(19) United States
(12) Patent Application Publication
(10) Pub. No.: US 2016/0348018 A1
(43) Pub. Date: Dec. 1, 2016

(54) GLYCOL REGENERATOR VAPOR RECOVERY UNIT

(71) Applicant: Gas Pro Compression Corp., Three Hills (CA)

(72) Inventors: Tom Nichols, Three Hills (CA); Peter Pattison, Three Hills (CA); Mustafa Siddiqui, Three Hills (AB)

(21) Appl. No.: 15/165,258

(22) Filed: May 26, 2016

(30) Foreign Application Priority Data
May 26, 2015 (CA) 2892633

(51) Int. Cl. C10L 3/10; B01D 53/00; B01D 53/14; B01D 53/26; B01D 53/18

(52) U.S. Cl. CPC C10L 3/106; C10L 3/101; B01D 53/263; B01D 53/18; B01D 53/1425; B01D 53/1487; B01D 53/002; C10L 2290/06; C10L 2290/30; C10L 2290/08; C10L 2290/543; B01D 2252/2023

(57) ABSTRACT

A vapor recovery system and method to control emissions (benzene and other compounds) from glycol regenerator overheads in a natural gas dehydration system is provided. In this system, a cooler is configured to receive overheads from a glycol regenerator and operative to condense at least a portion of the overheads into a cooled liquid stream. A storage tank is configured to receive the condensed overheads from the cooler for storage. A compressor is configured to compress the uncondensed vapor in the storage tank and push it into a wet natural gas stream coming into a compressor at a suction of the facility.

### FIELD

The present invention relates to a process and system of glycol dehydration for a natural gas dehydrating system and more specifically a process and system for vapor recovery that eliminates the emissions of BTEX and other compounds from a glycol dehydration operation.

### BACKGROUND

Natural gas dehydration is an important process to remove water vapor from natural gas flowing through pipe lines. Glycol (DEG, TEG etc.) is widely used to absorb water from natural gas in a dehydration process. However, glycol not only absorbs water vapor in the natural gas, but it can also absorb some quantities of the methane, ethane and other organic compounds including Benzene, Toluene, Ethylbenzene and Xylenes (collectively known as BTEX) that are present in the natural gas stream. These absorbed compounds are then released from the glycol during the regeneration process whereby the glycol mixture is heated to boil off water and other absorbed compounds, thus allowing the glycol to be used once again to dehydrate more natural gas.

Some of these compounds can be detrimental to the environment and the health of people. Benzene, for example, is a known carcinogen. As a result, government regulations restrict the allowable emission limits from dehydration facilities to prevent large amounts of benzene and other harmful compounds from potentially being released into the environment.

Several methods are in practice right now to contain the emissions coming off from the regenerator overheads where the BTEX and other compounds will be present. Some of these methods focus on cooling these overheads to cause them to condense and then storing the condensed liquids in a tank. However, while the BTEX and other compounds that have been condensed into a liquid are captured, the non-condensables (methane, ethane etc.) and quantities of BTEX and other compounds that may not have been fully condensed, are still emitted from the system as vapor. Additionally, the efficiency of the condensing of the BTEX and other compounds can significantly decrease if the ambient temperature is too high.

In other methods, the non-condensed BTEX and other compound vapors are directed to an incinerator or a flare to be burned. However, even though this reduces the BTEX emissions, there are still emissions from these processes. Furthermore the efficiency of the incinerator dictates what percentage of BTEX has been destroyed.

### SUMMARY OF THE INVENTION

It would be advantageous to have a vapor recovery system that efficiently reduces emissions of BTEX or other compounds from a glycol dehydration system.

In an aspect, a natural gas dehydration system comprises a first compressor configured to receive a wet natural gas stream, a contactor tower configured to receive wet natural gas from the first compressor and a supply of lean glycol, a glycol regenerator configured to receive the rich glycol from the flash tank and operative to heat the rich glycol to cause water vapour, BTEX, and other compounds to boil off and be removed from the glycol regenerator as overheads, a cooler configured to receive overheads from the glycol regenerator and operative to condense at least a portion of the overheads into a cooled liquid stream, and a storage tank configured to receive the condensed overheads from the cooler for storage.

In another aspect, a method for containing glycol regenerator overheads is provided. The method includes receiving overheads from a glycol regenerator and condensing at least a portion of the overheads into a cooled liquid, routing the cooled liquid to a storage and storing the cooled liquid and routing uncondensed vapor from the storage tank back into a wet natural gas stream.

The present invention can form a closed loop for the BTEX and other compounds and can reduce or eliminate the emissions of BTEX and other compounds from the natural gas dehydration system.

### DESCRIPTION OF THE DRAWINGS

A preferred embodiment of the present invention is described below with reference to the accompanying drawings, in which:

FIG. 1 is a schematic illustration of a natural gas dehydration system with vapor recovery.

### DETAILED DESCRIPTION OF THE ILLUSTRATED EMBODIMENTS

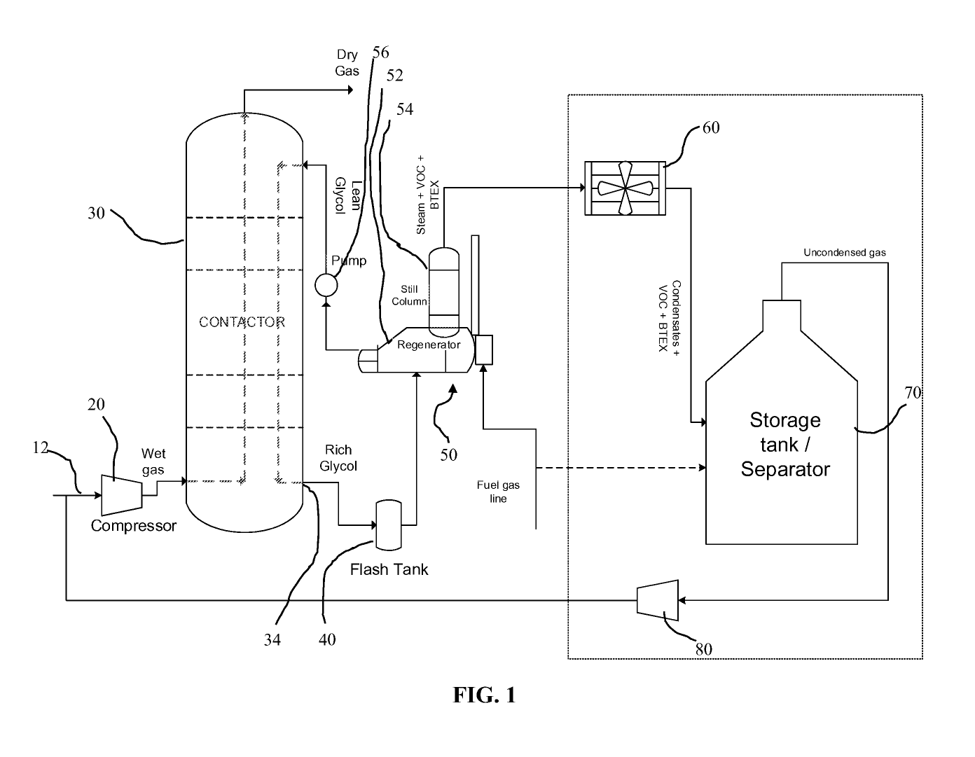

FIG. 1 illustrates a natural gas dehydration system 10 for removing water vapor from natural gas flowing through pipe lines while preventing BTEX and other compounds from being emitted from the system. The system 10 can include a first compressor 20 for compressing the incoming natural gas stream, a contactor tower 30 where water vapor is removed from the natural gas using glycol, a flash tank 40, a glycol regenerator 50, a cooler 60 to condense the overheads from the glycol regenerator 50, a storage tank 70 and a second compressor 80.

“Wet” natural gas (natural gas containing water vapor) enters the natural gas dehydration system 10 through an inlet 12 where it is directed to a first compressor 20 to compress the wet natural gas stream before it enters the contactor tower 30. Lean glycol (substantially water free glycol) is fed into the contactor tower 30 near the top of the contactor tower 30 where the lean glycol comes into contact with the compressed wet natural gas stream that has entered the contactor tower 30. The glycol will remove water vapor and other compounds including BTEX from the natural gas stream by physical absorption where the glycol comes into contact with the natural gas stream. The glycol, now often referred to as rich glycol because it includes water vapor and other compounds, is carried to the bottom of the contactor tower 30 where it is removed through a rich glycol outlet 34. The contactor tower 30 can use tray columns or packed columns to cause the glycol to come into contact with the ascending natural gas stream.

Dry natural gas that has been treated by the glycol and dehydrated, can exit the contactor tower 30 near or at the top of the contactor tower 30 and be directed to a pipeline system for transport, to a gas plant, storage facilities, etc.

After the glycol has been used to treat the natural stream and has exited the contactor tower 30 through the rich glycol outlet 34, the rich glycol can be directed to the flash tank 40. The flash tank 40 reduces the pressure of the rich glycol stream entering the flash tank 40 and this pressure reduction can cause most organic compounds to flash off as vapor.

After leaving the flash tank 40, the rich glycol is directed to the glycol regenerator 50 to remove the water vapor, BTEX and other compounds from the rich glycol to increase its purity so that it can once again be used in the contactor tower 30 to remove water vapor from the incoming wet natural gas stream. The glycol regenerator 50 can include a reboiler 52 and a still column 54. The resulting “lean” glycol is routed to a glycol pump 56 to be pressurized before being fed back into the contactor tower 30 to once again remove water vapor from the wet natural gas stream entering the contactor tower 30.

The reboiler 52 will heat the rich glycol causing the water vapor, BTEX and other compounds to boil off and enter the still column where they can be removed from the glycol regenerator 50 as overheads. Typically these overheads emissions are vented to atmosphere, sent to storage tank or burned.

These overheads can be directed to a cooler 60 where the overheads can be condensed into a cooled liquid stream and then sent to a storage tank 70. In the storage tank 70 liquids that have been condensed from the overheads exiting the glycol regenerator 50 settle down and can be stored. Any uncondensed vapor in the storage tank 70 can be routed to the second compressor 80 to increase the pressure of this uncondensed vapor so that it can be pushed into the suction inlet of the first compressor 20 and mixed with the incoming wet natural gas stream entering the first compressor 20.

In this manner, there will essentially be no emissions of BTEX or other compounds from the natural gas dehydration system 10. BTEX in vapor form that remains in the natural gas stream after treatment in the contactor tower 30 will simply remain in the dry natural gas and be directed to the pipeline system for transport, gas plant, storage facilities, etc. with the dry natural gas. The BTEX or other compounds that are absorbed by the glycol in the contactor tower 30 will be removed as part of the overheads in the glycol regenerator 50 and either remain in the liquid in the storage tank 70 or if in vapor form, passed back into the wet natural gas to be treated in the contactor tower 30 and either exit with the treated dry natural gas or some might be reabsorbed into the glycol. This forms a closed loop for the BTEX and these other compounds and reduces or eliminates the emissions of this BTEX and other compounds from the natural gas dehydration system 10.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A natural gas dehydration system comprising:
a first compressor configured to receive a wet natural gas stream;
a contactor tower configured to receive wet natural gas from the first compressor and a supply of lean glycol;
a glycol regenerator configured to receive the rich glycol from the flash tank and operative to heat the rich glycol to cause water vapour, BTEX, and other compounds to boil off and be removed from the glycol regenerator as overheads;
a cooler configured to receive overheads from the glycol regenerator and operative to condense at least a portion of the overheads into a cooled liquid stream; and
a storage tank configured to receive the condensed overheads from the cooler for storage.

2. The system of claim 1, wherein the contactor tower is configured to allow contact between the wet natural gas and the lean glycol at a top end of the contactor tower and is operative to carry rich glycol to a bottom end of the contactor tower for removal through a rich glycol outlet.

3. The system of claim 1, wherein the contactor tower comprises at least one of tray columns and packed columns.

4. The system of claim 1, wherein the glycol generator is configured to feed lean glycol from the glycol regenerator into the contactor tower.

5. The system of claim 4, further comprising a glycol pump configured to receive lean glycol from the glycol regenerator and operative to pressurize the lean glycol and transfer the lean glycol to the contactor tower.

6. The system of claim 1, wherein the glycol regenerator comprises a reboiler and a still column.

7. The system of claim 6, wherein the reboiler is operative to heat the rich glycol to cause the overheads to boil off and enter the still column.

8. The system of claim 1, further comprising a second compressor configured to receive uncondensed vapor from the storage tank and operative to increase the pressure of the uncondensed vapor, and further configured to route the resulting compressed vapor to the first compressor whereby it can be mixed with the wet natural gas stream entering the first compressor.

9. A method for controlling emissions from glycol regenerator overheads in a dehydration system, the method comprising:
receiving overheads from a glycol regenerator and condensing at least a portion of the overheads into a cooled liquid;
routing the cooled liquid to a storage and storing the cooled liquid; and
routing uncondensed vapor from the storage tank back into a wet natural gas stream.

10. A method for removing water vapor from wet natural gas, the method comprising:
providing a wet natural gas stream;
compressing the wet natural gas stream;
contacting lean glycol with the compressed wet natural gas stream to produce rich glycol;
heating the rich glycol to cause water vapour, BTEX, and other compounds to boil off as overheads and to produce lean glycol;
condensing at least a portion of the overheads;
compressing uncondensed vapor from the overheads; and
contacting the compressed vapor from the overheads with the compressed wet natural gas stream.

11. The method of claim 10, wherein the step of contacting the compressed wet natural gas stream and the lean glycol occurs at a top end of a contactor tower.

12. The method of claim 11, further comprising the step of carrying rich glycol to a bottom end of the contactor tower and removing the rich glycol from the contactor tower at a bottom end of the contactor tower.

13. The method of claim 10, wherein the step of contacting the compressed wet natural gas stream and the lean glycol comprises using at least one of tray columns and packed columns.

14. The method of claim 10, further comprising the step of routing the lean glycol to be contacted with the wet natural gas stream.

15. The method of claim 14, further comprising the step of pressurizing the lean glycol prior to routing the lean glycol to be contacted with the wet natural gas stream.

16. The method of claim 10, further comprising the step of storing the condensed overheads in a storage tank.
